(19) United States
(12) Patent Application Publication
(10) Pub. No.: US 2014/0015274 A1
(43) Pub. Date: Jan. 16, 2014

(54) Emergency Hail Shield for Motor Vehicles

(71) Applicant: Roland Banda, San Antonio, TX (US)

(72) Inventor: Roland Banda, San Antonio, TX (US)

(21) Appl. No.: 13/549,358

(22) Filed: Jul. 13, 2012

(51) Int. Cl. B60J 11/04

(52) U.S. Cl. 296/136.02

(57) ABSTRACT

A rapidly installable for protecting upwardly facing horizontal surfaces of a motor vehicle from falling hail. The barrier may comprise a cover sheet which covers upwardly exposed surfaces of the motor vehicle and an absorbent panel capable of resisting impact of hail. The absorbent panel may comprise an array of parallel cushion panels having a folding joint disposed between each two adjacent cushion panels. The cushion panels may be enclosed within a sleeve which protects them from liquid and solid contaminants, and preferably, ultraviolet rays. The sleeve may comprise one common sleeve, or plural sleeves each enclosing one or more cushion panels. The barrier may include magnets enclosed within the sleeve or sleeves for adhering to steel vehicle bodies, and straps bearing connectors for engaging axle components of the motor vehicle.

### FIELD OF THE INVENTION

The present invention relates to covers and protectors, and more particularly to a cover or protector for protecting motor vehicles from hail.

### BACKGROUND OF THE INVENTION

Hail storms are notorious for inflicting considerable damage to motor vehicles. A hail storm may arise with little warning, and may release hailstones as large as a softball. This obviously has potential to wreak considerable damage to windows and external body panels of motor vehicles.

While hail damage may be an expense and an inconvenience to individual owners of motor vehicles, it can be financially disastrous to dealers of new and used motor vehicles, who may see their entire retail operation brought to a standstill for weeks if not longer as a result of hail damage to vehicles in inventory.

It has been proposed to provide covers to protect against hail damage in the past. However, there remains a need for a quickly deployable, inexpensive cover for warding off hail damage to motor vehicles.

### SUMMARY OF THE INVENTION

The present invention addresses the above stated need by providing an effective hail barrier or shield which is expeditiously installed on a motor vehicle. The hail barrier may comprise a structural substrate or cover sheet and at least one cushion panel enclosed within an outer protective sleeve, fixed to the cover sheet. The cushion panel is of suitable constituency for absorbing energy of hail stones impinging thereagainst. The protective sleeve encloses the cushion panel and prevents the latter from scratching automotive finishes. Also, because the cushion panel may be of open cell foam construction, the protective sleeve opposes ingress of water and environmental contaminants into the cushion panels. Preferably, the outer sleeve is resistant to ultraviolet rays such as UVA, UVB, and UVC. This protects plastics from deterioration due to exposure to ultraviolet rays.

Unlike other vehicle covers and protectors, the novel hail barrier is generally limited to cover and protect horizontal surfaces of a motor vehicle. To that end, and also to expedite installation, the cushion panels extend only minimally along vertical surfaces of the motor vehicle, terminating just above fender openings for example.

The hail barrier may be fixed in place on the motor vehicle by straps, assisted by magnets which may be sewn into the cover sheet.

In a particularly advantageous application of the invention, a motor vehicle retail dealer may protect inventory which is typically kept outside on paved lots or the like, where the motor vehicles are directly exposed to hail. Because hail storms can develop quickly, the novel barrier is readily unrolled for deployment and fixed to the vehicle.

It is an object of the invention to provide improved elements and arrangements thereof by apparatus for the purposes described which is inexpensive, dependable, and fully effective in accomplishing its intended purposes.

This and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic environmental side view of a hail resistant barrier according to at least one aspect of the invention.

FIG. 2 is a side detail view taken from the left of FIG. 1, but showing a connector unconnected, and is drawn to enlarged scale.

FIG. 3 is a side cross sectional detail view of the top of FIG. 1.

FIG. 4 is similar to FIG. 3, but shows an alternative construction of the subject component.

FIG. 5 is similar to FIG. 3, but shows a further alternative construction.

FIG. 6 is a top plan view of the hail barrier of FIG. 1, showing the latter fully unrolled.

FIG. 7 is an environmental side view of the hail barrier of FIG. 6, shown immediately prior to unrolling.

FIG. 8 is an exploded perspective detail view of the upper left of FIG. 1.

### DETAILED DESCRIPTION

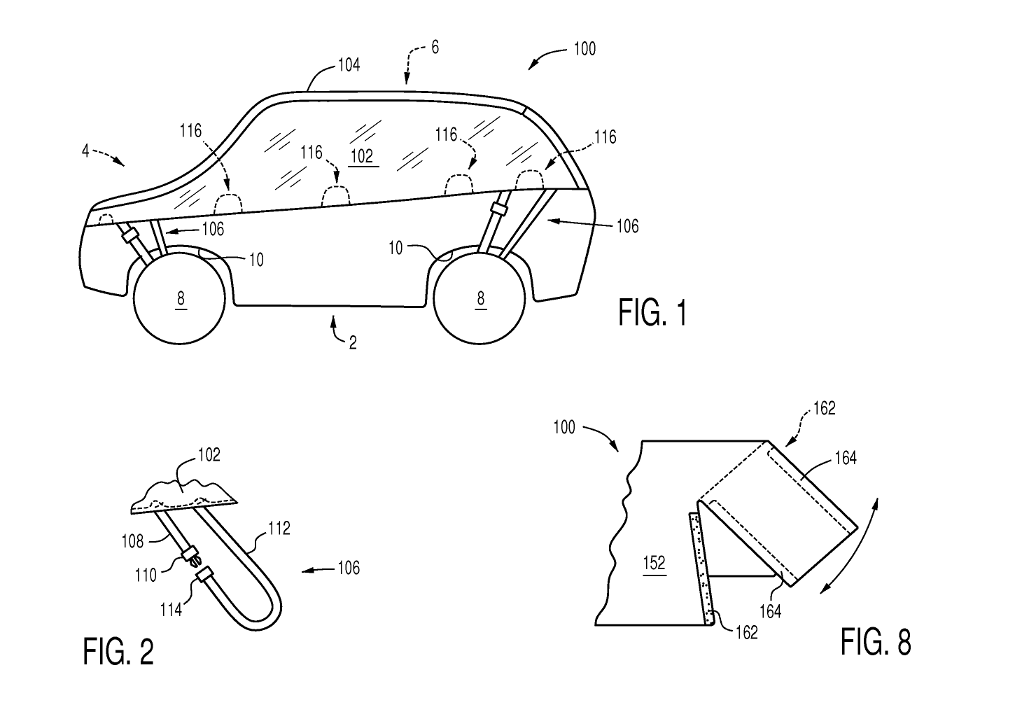

FIG. 1 shows a hail resistant barrier 100 for protecting a motor vehicle 2, according to at least one aspect of the invention. The hail resistant barrier 100 is intended to be placed on an upwardly facing horizontal surface, such as the hood 4, roof 6, and for vehicles having body styles including such a feature, a trunk (not shown), which upwardly facing horizontal surface would be exposed to falling hail (not shown), as depicted in FIG. 1.

It should be noted at this point that orientational terms such upwardly refer to the subject drawing as viewed by an observer. The drawing figures depict their subject matter in orientations of normal use, which could obviously change with changes the orientation of the motor vehicle being protected. FIG. 1 therefore will be understood to depict the hail resistant barrier installed in the operative condition on the motor vehicle 2. Orientational terms therefore will be understood to provide semantic basis for purposes of description, and do not limit the invention or its component parts in any particular way.

The hail resistant barrier 100 The number, location, length, spacing and other characteristics of the straps such as the straps 102 may be varied to suit the intended purpose, and may vary with hail resistant barriers intended for use with particular models of vehicles for example.

The hail resistant barrier 100 may comprise a cover sheet 102 which is dimensioned and configured to be installed in the operative condition on and to cover the motor vehicle 2 from the top or upwardly facing surface, and to extend downwardly on the lateral sides of the motor vehicle a sufficient distance to enable securement of the cover sheet 102 to the motor vehicle 2. The cover sheet 102 serves as a structural substrate for engaging the motor vehicle 2 and to anchor a protective cushion panel 104. The cushion panel is formed from a material which can absorb energy of falling hail (not shown). Whereas the cover sheet 100 may drape over vertical surfaces of the motor vehicle, the cushion panel 104, which is located at upwardly facing surfaces of the cover sheet 102 when the cover sheet 102 is installed in the operative condition, the cushion panel 104 is generally limited to cover only horizontal surfaces of the motor vehicle 2.

The hail resistant barrier 100 may be attached to the motor vehicle 2 by a plurality of attachment straps 106 disposed to engage the motor vehicle 2 for purposes of securing the cover sheet 102 to the motor vehicle 2. Preferably, there are four attachment straps 106, each disposed near one of the wheels 8 of the motor vehicle 2. Because the hail resistant barrier 100 is primarily intended for protection against downwardly falling hail, it is not necessary to cover lateral surfaces of the motor vehicle 2. Hence, the cover sheet 102 need depend downwardly from the roof 6 no further than wheel openings 10 formed in the body of the motor vehicle 2 when the cover sheet 102 is installed in the operative condition.

The hail resistant barrier 100 may be conveniently fixed to the motor vehicle 2 by encircling a component of the axles (not separately shown) of the motor vehicle 2. For the purposes of this invention, axle components may include not only literally axle components such as axle shafts, but also suspension components such as A-arms, steering components, and other sturdy components of the vehicle which may be readily encircled by the attachment straps 106.

Referring also to FIG. 2, each attachment strap may comprise a relatively short section 108 terminating in a male connector 110 and a complementing, relatively long second section 112 terminating in a female connector 114. The male connector 110 and female connector 114 may operate by resilient spreading and closing of the legs of the male connector 110. This arrangement may be of a commercially available type in widespread use for luggage, backpacks, and the like (none shown) for example. The relatively long second section 112 may be passed around the axle component and connected to the relatively short section. With the relatively short section 108 and the relatively long section 112 connected to form a single strap, the strap may be adjusted by an optional cinch feature (not shown) which may, as with the connectors, be of a commercially available type in widespread use.

Another feature seen in FIG. 1 is a plurality of magnets 116 which may be entrapped within the cover sheet 102 by stitching 118 for example, such that each magnet 116 is not directly exposed to the motor vehicle 2 when the hail resistant barrier is installed thereon. The magnets 116 may be spaced about the periphery of the cover sheet 102 to promote engagement of a steel body of the motor vehicle 2 when the cover sheet is installed in the operative condition.

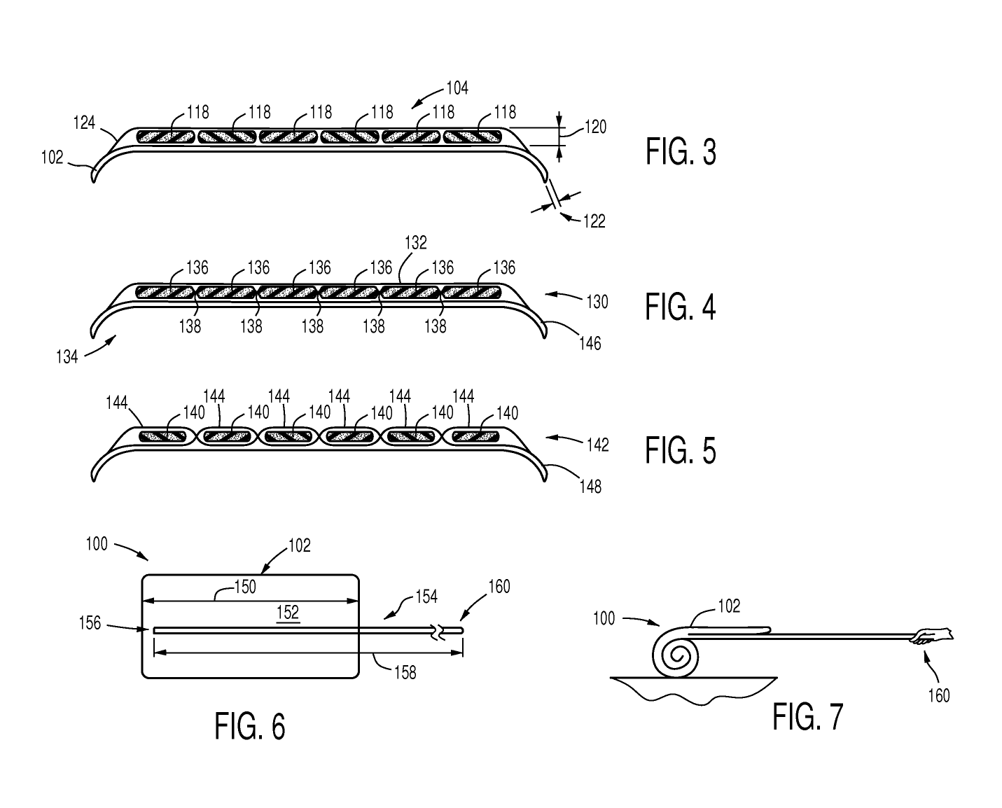

FIG. 3 shows one of several possible forms of the cushion panel 104. The cushion panel 104 may be formed as a plurality of cushion panel sections 118 each having a foldable joint disposed between adjacent cushion panels 118. In the example of FIG. 3, the foldable joint comprises a discontinuity or gap between adjacent cushion panels 118. There is no constituent material in this discontinuity or gap which would oppose folding of the cushion panel 104 for stowage despite the fact that the thickness 120 of the cushion panel 104 may be somewhat greater than the thickness 122 of the cover sheet 102. the cushion panel 104 may of course comprise a flexible protective sleeve 124 which envelops the cushion panel sections 118, which protective sleeve 124 may be suitably bonded to the cover sheet 102 by stitching, plastic welding, or in any other suitable way.

It should be noted that the drawings are diagrammatic and not literal in that for example, the cushion panels 118 are depicted spaced apart from the sleeve 124. This presentation is only for visual clarity. In practice, the sleeve 124 may directly contact the cushion panels 118.

FIG. 4 shows another construction for a cushion panel 130, which may in other ways be a functional equivalent of the cushion panel 104. The cushion panel 130 may comprise a flexible protective sleeve 132 which encloses a cushion 134. The cushion 134 may comprise a series of plank-like sections 136 joined by foldable joints each comprising respective narrowed sections 138 of the constituent material of two adjacent cushion panel sections 136. The narrowed sections 138 may extend between and be formed integrally with two adjacent cushion panel sections 136.

Whereas the two adjacent cushion panel sections 136 and their associated foldable joints 138 are enclosed in common within the sleeve 132 in FIG. 4, each individual cushion panel section 140 of a cushion panel 142 may be fully enclosed within a separate sleeve 144, as shown in FIG. 5.

Regardless of how cushion panels such as the cushion panels 118, 140 and the cushion 134 are arranged, each cushion panel is ultimately bonded to a cover sheet 102 (FIG. 3), 146 (FIG. 4), or 148 (FIG. 5). The cover sheets 102, 146, 148 may protect their associated cushion panels in several ways. The sleeves may be fabricated at least partially from watertight constituent material, and may be impregnated with a material which resists ultraviolet light. The cushion panels may have constituency of high density polyethylene or a like material, and may take various forms including open or closed cell foams, woven and non-woven fabrics, adjacent sheets adapted to define air bubbles or cells, and still others.

Preferably, the upwardly exposed face of the sleeve such as the sleeve 124 would be the minimum portion of the entire sleeve 124 which would comprise watertight or water resistant material, and which comprises the material which resists ultraviolet light. Watertight or water resistant material may be inherent in the constituent material of the sleeve, or may comprise a material added to the constituent material to impart the desired quality. The same holds true of the material which resists ultraviolet light. Additives suitable for use with elastomeric materials which confer water and ultraviolet light resistance are known and need not be detailed further herein.

Regardless of internal construction, as that applies to the options of FIGS. 3, 4, and 5, each cushion panel section such as the cushion panel sections 118, 140, or the unitary assembly of the cushion 134 has a length which is oriented perpendicularly to the length (indicated by the arrow 150 in FIG. 6) of the cover sheet such as the cover sheet 102. The foldable joints of the cushion panel 134 or cushion panel sections 118 or 140 are arranged parallel to one another. This facilitates rolling up the hail resistant barrier (such as the hail resistant barrier 100, which will serve in representative capacity for explanation of stowage and installation of many types of hail resistant barriers according to the invention) for stowage, as seen in FIG. 7. The rolled hail resistant barrier 100 may be expeditiously unrolled when being installed on a motor vehicle such as the motor vehicle 2. To this end, the cover sheet 102 comprises a main section 152 having the length 150 which is aligned with the length of the motor vehicle 2 when the cover sheet 102 is installed in the operative condition. A pull strap 154 having a fixed end 156 which is anchored to one end of the main section 152 of the cover sheet 102 has a length (indicated by the arrow 158) greater than the length of the main section 152 of the cover sheet 102. The pull strap 154 may be utilized in the following way. As seen in FIG. 7, the cover sheet 102 may be placed on a surface of the motor vehicle such as the roof 6. The mail section 152 may be unrolled from the rolled configuration seen in FIG. 7 by placing the main section 152 in the rolled condition on the motor vehicle 2 and pulling on the pull strap 154 in a manner which causes the main section 152 to unroll in the same direction as that along which the pull strap 154 is being pulled.

The free end 160 of the pull strap 154 may be grasped by and pulled to the right as seen in FIG. 7. This will unroll the rolled up hail barrier 100 until the hail barrier 100 is spread across the entire roof 6 of the motor vehicle 2. The attachments straps 106 (see FIG. 1) may then be deployed to secure the hail barrier 100 in place. The pull strap 154 may be quite long, for example possibly exceeding twice the length 150 of the cover sheet 102. This is to enable a person to stand immediately behind the motor vehicle 2 while the hail barrier 100 is at the front end of the motor vehicle, having just been placed in the initial position depicted in FIG. 7, and to walk away from the motor vehicle 2 while grasping and pulling the pull strap 154 until the cover sheet 102 is fully unrolled.

FIG. 8 shows a tail section 160 which may be an extension of the main section 152 of the cover sheet 102. The main section 152 and the tail section 160 may each have respective patches 162, 164 of hook and loop fastener for retaining the tail section 160 to the main section 152 at the seams bearing the patches 162, 164. The reason for providing the tail section 160 in the form shown herein is to promote orderly rolling and unrolling of the main section 152, and to enable the main section to be compact when rolled up for stowage.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A hail resistant barrier for protecting motor vehicles having upwardly facing horizontal surfaces against falling hail, comprising:
a cover sheet which is dimensioned and configured to be installed in an operative condition on and to cover a motor vehicle from the top, and to extend downwardly on the lateral sides of the motor vehicle a sufficient distance to enable securement of the cover sheet to the motor vehicle, wherein the cover sheet has a thickness;
at least one cushion panel formed from a material which can absorb energy of falling hail, and which is located at upwardly facing surfaces of the cover sheet when the cover sheet is installed in the operative condition on the motor vehicle, wherein the cushion panel is greater in thickness than is the cover sheet; and
a plurality of attachment straps disposed to engage the motor vehicle for purposes of securing the cover sheet to the motor vehicle.

2. The hail resistant barrier of claim 1, wherein the plurality of attachment straps comprises four attachment straps each disposed near one of the wheels of the motor vehicle when the cover sheet is installed in the operative condition on the motor vehicle.

3. The hail resistant barrier of claim 2, wherein each one of the attachments straps comprises first section including a male connector and a complementing second section including a female connector, whereby each one of the attachment straps may encircle an axle component of the motor vehicle when the cover sheet is installed in the operative condition on the motor vehicle.

4. The hail resistant barrier of claim 1, further comprising a plurality of magnets entrapped within the cover sheet such that the magnet is not directly exposed to the motor vehicle when the hail resistant barrier is installed on the motor vehicle, for promoting engagement of a steel body of the motor vehicle when the cover sheet is installed in the operative condition on the motor vehicle.

5. The hail resistant barrier of claim 1, wherein the cover sheet comprises a main section and a tail section, and the cover sheet and the tail section each have respective patches of hook and loop fastener enabling the tail section to be manually connected to and removed from the main section.

6. The hail resistant barrier of claim 1, wherein
the cover sheet comprises a main section having length which is aligned with the length of the motor vehicle when the cover sheet is installed in the operative condition on the motor vehicle, and
a pull strap which is anchored to one end of the main section of the cover sheet and which has length greater than the length of the main section of the cover sheet, whereby the main section may be unrolled from a rolled configuration by placing the main section in the rolled condition on the motor vehicle and pulling on the pull strap in a manner which causes the main section to unroll in the same direction as that along which the pull strap is being pulled.

7. The hail resistant barrier of claim 1, wherein the cushion panel is formed as a plurality of cushion panel sections each having a foldable joint disposed between adjacent cushion panels.

8. The hail resistant barrier of claim 7, wherein each cushion panel section has a length which is oriented perpendicularly to the length of the cover sheet, and wherein the foldable joints disposed between adjacent cushion panels are arranged parallel to one another.

9. The hail resistant barrier of claim 7, further comprising a sleeve, wherein the foldable joint comprises a narrowed section of constituent material of two adjacent cushion panels, extending between and formed integrally with the two adjacent cushion panels, and wherein the two adjacent cushion panels and the foldable joint are enclosed in common within the sleeve.

10. The hail resistant barrier of claim 9, wherein the sleeve at least partially comprises watertight constituent material.

11. The hail resistant barrier of claim 9, wherein the sleeves at least partially comprise a material which resists ultraviolet light.

12. The hail resistant barrier of claim 7, further comprising a separate sleeve for each cushion panel, and each cushion panel is fully enclosed within one of the sleeves.

13. The hail resistant barrier of claim 12, wherein each one of the sleeves at least partially comprises watertight constituent material.

14. The hail resistant barrier of claim 12, wherein the sleeves at least partially comprise a material which resists ultraviolet light.

15. The hail resistant barrier of claim 1, wherein the cover sheet depends downwardly from the roof of the vehicle no further than wheel openings formed in the body of the motor vehicle when the cover sheet is installed in the operative condition on the motor vehicle.
